(19) United States
(12) Patent Application Publication
(10) Pub. No.: US 2007/0186027 A1
(43) Pub. Date: Aug. 9, 2007

(54) Method and apparatus for implementing control of a multiple ring hybrid crossbar partially non-blocking data switch

(75) Inventors: Danny J. Klema, Rochester, MN (US); David John Krolak, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/348,825

(22) Filed: Feb. 7, 2006

(51) Int. Cl. G06F 13/00; G06F 13/14; G06F 13/38

(52) U.S. Cl. 710/317; 710/240

(57) ABSTRACT

A method and control apparatus are provided for implementing control of a multiple-ring hybrid crossbar partially non-blocking data switch, the data switch including a plurality of bus units, each bus unit coupled to a respective data ramp and a plurality of data rings connected between each of the data ramps, with each data ramp device only connected to the two adjacent data ramp devices. Control apparatus includes one request handler per bus unit, one destination arbiter per bus unit, and one ring arbiter per ring. The request handler receives a request from an associated bus unit and saves the pending request state until a grant to the bus unit occurs. The request includes a destination unit identifier. The request handler forwards the request to the destination arbiter for the destination unit and the destination arbiter grants the request. Responsive to the destination arbiter granting the request, the request handler individually asks one of the ring arbiters to use the respective ring. One of the ring arbiters arbitrates between its request handler requests and issues a grant and then controls the flow of data around the ring.

### FIELD OF THE INVENTION

The present invention relates generally to the data processing field, and more particularly, relates to a method and apparatus for implementing control of a multiple-ring hybrid crossbar partially non-blocking data switch.

### DESCRIPTION OF THE RELATED ART

Transmission of data between multiple processing units within a single chip can be difficult. This problem has become important due to the proliferation of a multiple processing units on a chip. There are many specific problems relating to the transmission of data between these units on the same chip. Data coherency, substantial area on the chip, and power consumption are a few problems with these transmissions of data. Furthermore, attempting to achieve higher transfer rates exacerbates these problems. Transfer rates can be an exceptional problem when the processing units are large enough that the time required to propagate a signal across one unit approaches the cycle time of the data bus in question.

Some solutions, such as a conventional shared processor local bus, do not achieve a high enough bandwidth. This result negatively impacts the data transfer rate on the chip. Another conventional solution is a full crossbar switch. This type of switch cross connects each port to all the other ports. This means that a full crossbar switch requires N×N connections, adding to the complexity of the switch. This solution consumes too much area on the chip and requires extensive wiring resources. It is clear that a new method or apparatus is needed enable the transmission of data between multiple processing units on the same chip, while retaining a high data transfer rate.

U.S. patent application Ser. No. 11/077,330 filed Mar. 10, 2005 by Jeffery D. Brown, Scott D. Clark, Charles R. Johns, and David J. Krolak discloses a hybrid crossbar partially non-blocking data switch with a single port per attached unit and multiple rings, ring-based crossbar data switch, a method and a computer program are provided for the transfer of data between multiple bus units in a memory system. Each bus unit is connected to a corresponding data ramp. Each data ramp is only directly connected to the adjacent data ramps. This forms at least one data ring that enables the transfer of data from each bus unit to any other bus unit in the memory system. A central arbiter manages the transfer of data between the data ramps and the transfer of data between the data ramp and its corresponding bus unit. A preferred embodiment contains four data rings, wherein two data rings transfer data clockwise and two data rings transfer data counter-clockwise.

The subject matter of the above-identified U.S. patent application Ser. No. 11/077,330 is incorporated herein by reference.

A need exists for an effective and efficient mechanism for controlling a multiple-ring hybrid crossbar partially non-blocking data switch.

As used in the following description and claims, the terms “bus unit” and “bus device” are used interchangeably and mean any logical device for exchanging data with another logical device; for example, including but not limited to, a memory controller, an Ethernet controller, a central processing unit (CPU), a peripheral component interconnect (PCI) express controller, a universal serial bus controller, and a graphics adapter unit.

As used in the following description and claims, the terms “data ramp” and “ramp” are used interchangeably and mean a data transmission device in a data switch fabric.

### SUMMARY OF THE INVENTION

Principal aspects of the present invention are to provide a method and apparatus for implementing control of a multiple-ring hybrid crossbar partially non-blocking data switch. Other important aspects of the present invention are to provide such method and apparatus for implementing control of a multiple-ring hybrid crossbar partially non-blocking data switch substantially without negative effect and that overcome many of the disadvantages of prior art arrangements.

In brief, a method and control apparatus are provided for implementing control of a multiple-ring hybrid crossbar partially non-blocking data switch, the data switch including a plurality of bus units, each bus unit coupled to a respective data ramp and a plurality of data rings connected between each of the data ramps, with each data ramp device only connected to the two adjacent data ramp devices. Control apparatus includes one request handler per bus unit, one destination arbiter per bus unit, and one ring arbiter per ring. The request handler receives a request from an associated bus unit and saves the pending request state until a grant to the bus unit occurs. The request includes a destination unit identifier. The request handler forwards the request to the destination arbiter for the destination unit and the destination arbiter grants the request. Responsive to the destination arbiter granting the request, the request handler individually asks one of the ring arbiters to use the respective ring. One of the ring arbiters issues a grant and then controls the flow of data around the ring.

In accordance with features of the invention, the destination arbiter prevents multiple units from sending to the same destination at the same time. The destination arbitration arbitrates between each of multiple requester handlers, for example, in a round-robin fashion; and notifies the winning request handler. A request handler cannot initiate a pending request to the ring arbiter until it has won its destination. This prevents deadlocks on the rings and data collisions from multiple transactions arriving at the destination simultaneously.

In accordance with features of the invention, the plurality of data rings includes clockwise and counterclockwise rings. The request handler calculates a path from the requester to the destination for both the clockwise and the counterclockwise rings. The path calculation is a simple decode based on the relative positions of requestor and destination on a ring.

In accordance with features of the invention, the request handler calculates whether the path to the destination is free or not on each ring using signals received from the ring arbiters. A path is considered “free” on a ring if the requestor's node on that ring is not in use, and the “tail” bit for that node on that ring is not in use. The request handler uses a path-free and destination winner state to select a ring for an initial request to one of the respective ring arbiters.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation of an exemplary hybrid crossbar partially non-blocking data switch with a single port per attached unit and multiple rings for implementing control methods in accordance with the preferred embodiment;

FIGS. 2 and 3 are timing diagrams respectively illustrating timings for a sending unit and for a receiving unit in accordance with the preferred embodiment;

FIG. 4 is a timing diagram illustrating exemplary operations of the hybrid crossbar partially non-blocking data switch of FIG. 1 for a data transaction on a selected data ring in accordance with the preferred embodiment; and

FIG. 5 is a block diagram illustrating exemplary controller apparatus for the hybrid crossbar partially non-blocking data switch of FIG. 1 in accordance with the preferred embodiment.

### DETAILED DESCRIPTION OF THE PREFERRED EMBODIMENTS

In accordance with features of the invention, a method and apparatus are provided for implementing control of a hybrid crossbar partially non-blocking data switch. Novel features of the controller of the preferred embodiment include a Source-Destination Path Calculation; Ring selection, activation, and control; Destination Conflict Avoidance; Source Conflict Avoidance; Path conflict Avoidance; Deadlock Avoidance; and Livelock Avoidance.

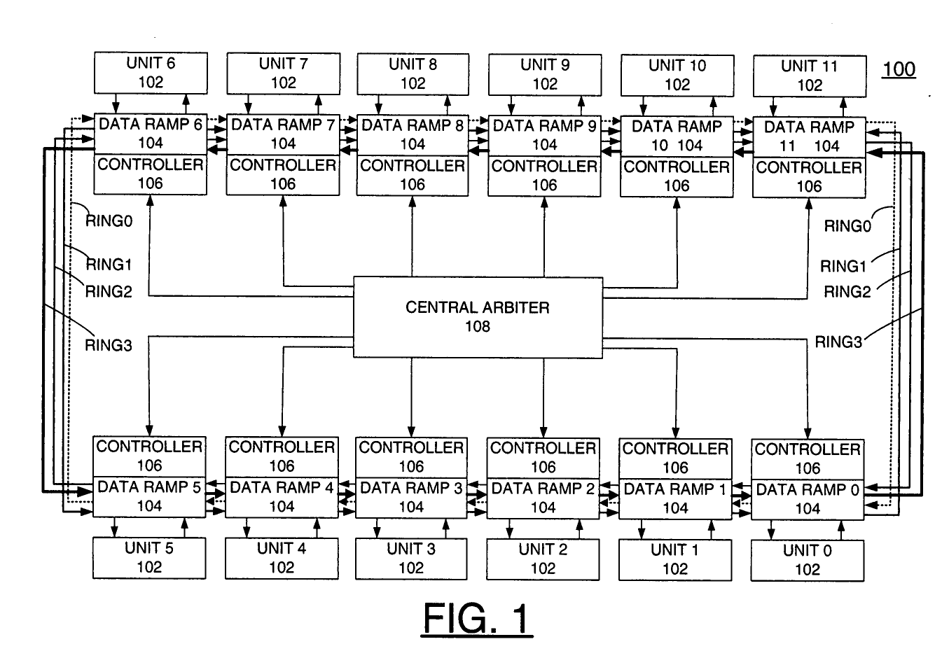

Having reference now to the drawings, in FIG. 1, there is shown exemplary hybrid crossbar partially non-blocking data switch generally designated by the reference character 100 for implementing control methods in accordance with the preferred embodiment. Hybrid crossbar partially non-blocking data switch 100 includes a plurality of bus units 0-11, 102. Each bus unit 0-11, 102 is connected to a respective, associated data ramp 0-11, 104. A respective, associated controller 0-11, 106 of the preferred embodiment is provided with each data ramp device 0-11, 104. Hybrid crossbar partially non-blocking data switch 100 includes a central arbiter 108 that sends control signals to the respective controllers 0-11, 106 of the preferred embodiment.

Hybrid crossbar partially non-blocking data switch 100 includes four rings RING0, RING1, RING2, RING3 connected between each of the data ramps 0-11, 104, with each data ramp only connected to the two adjacent data ramps. Two data rings RING0, RING2 transfer data clockwise, and two data rings RING1, RING3 transfer data counterclockwise.

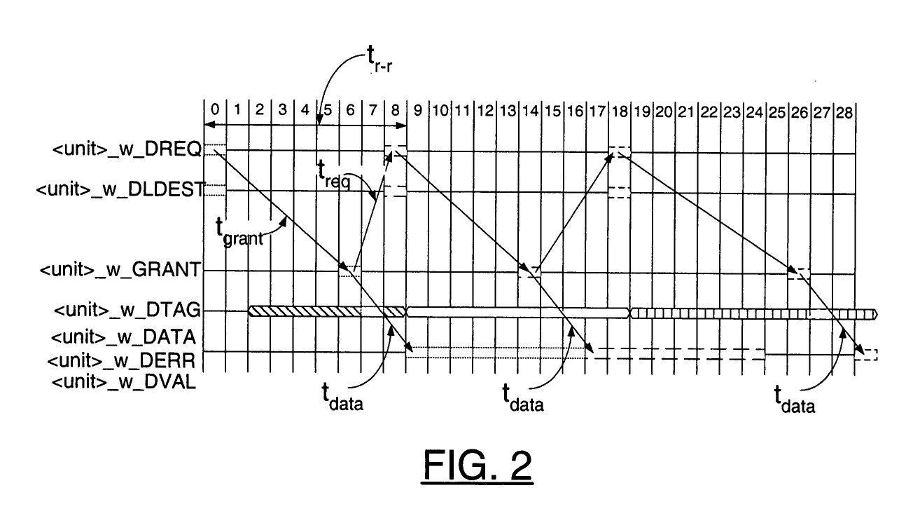

FIG. 2 illustrates timings for a sending unit. The DREQ and DLDEST lines attach to the central arbiter 108, which returns the DGRANT. The other lines connect to the unit's data ramp 104. In FIG. 2, t_{grant} is a Request to Grant Delay, where, t_{grant} is ≧bus cycles. The indicated treq represents Grant to next Request Delay, t_{req} is ≧2 bus cycles. The indicated t_{data} represents Grant to data delay is 3 bus cycles. The indicated tᵣ₋ᵣ represents DREQ to DREQ delay, tᵣ₋ᵣ is ≧8 bus cycles.

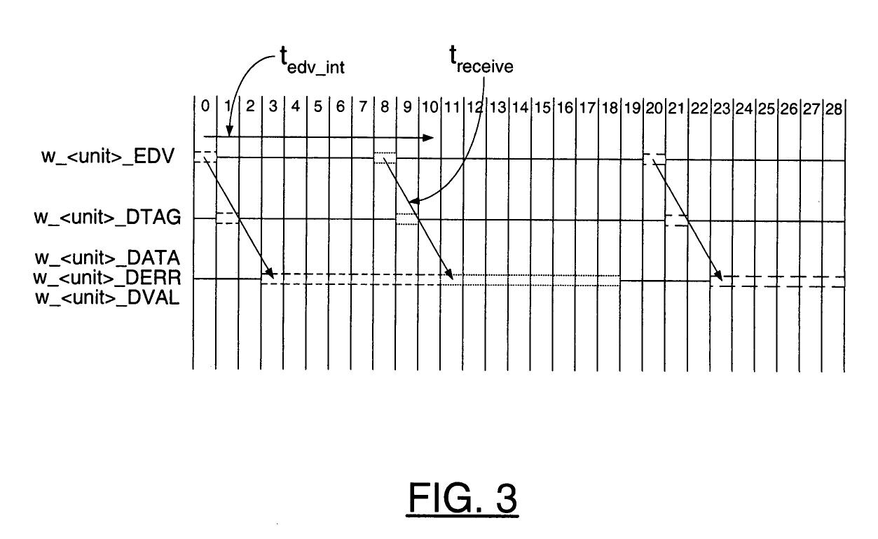

FIG. 3 illustrates timings for a receiving unit. The central arbiter 108 sends the EDV to the receiving unit, and then it then receives the other signals from its data ramp 104 as shown. In FIG. 3, t_{receive} is an Early Data Valid to DATA receive, t_{receive}=t_{data} represents 3 clocks as defined for Unit Data Send Interface. The indicated t_{edv—int} represents an Early Data Valid Interval—time between adjacent w_<unit>_EDV, t_{edv—int}≧8 bus clocks.

In accordance with features of the invention, controllers 106 for the multiple-ring-based hybrid crossbar switch 100 collects requests to send data from the bus units or bus devices 102, arbitrates among the requests, select one of the data rings RING0, RING1, RING2, RING3 on which to transport the data for each request, and manages the flow of data from the source to the destination.

It is assumed that each request will generate 8 beats of data, but it should be understood that adaptations to this method can accommodate variable length transfers.

It should be understood that the present invention is not limited to the illustrated embodiment, for example, those skilled in the art can adapt these methods to work with a larger or smaller number of rings and nodes.

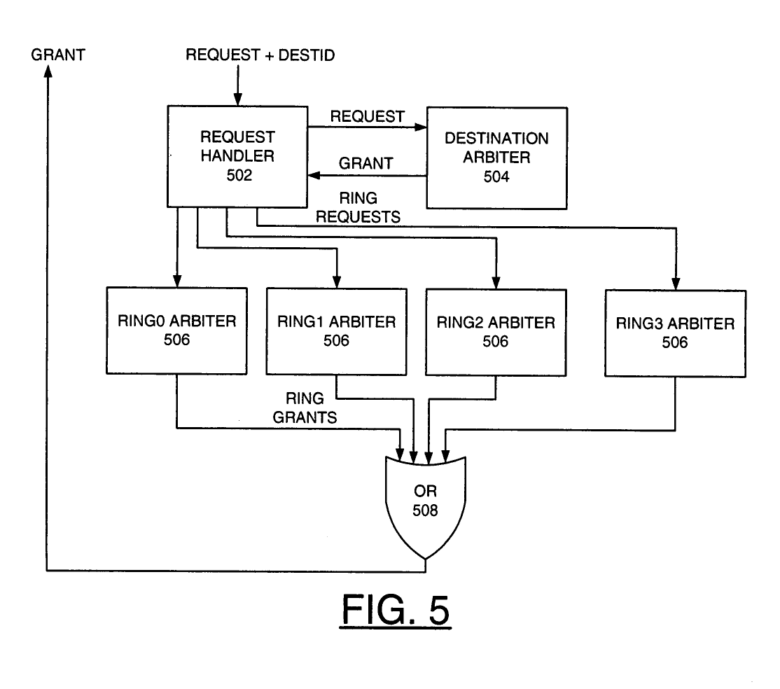

Controller 106 is described for use with the four, 12-node rings RING0, RING1, RING2, RING3, and controller apparatus 106 is further illustrated and described with respect to FIG. 5. It should be understood that the present invention is not limited to the illustrated controller 106, for example, the controller can be adapted for use with a different number of both nodes and rings.

Data Ring Operating Rules:

Each Data Ramp 104 provides a simple entry and exit port for the bus device or unit 102 into the multiple ring structure. Data Ramp 104 takes one bus cycle for data to pass from the source device to its ramp, one bus cycle for data to pass from one data ramp to the next data ramp in the ring, and once the data reaches the destination ramp, it takes one bus cycle to pass from that data ramp to the receiving device.

A requesting device 104 raises its data request line along with a 4-bit destination unit ID. The central arbiter 108 arbitrates and eventually returns a Grant to the requester as well as a ring-specific Grant to the corresponding data ramp controller.

The cycle after the Grant, the requester drives its DataTag on-ramp for 1 bus cycle. The DTag is 14 bits plus the Partial Transfer Indicator bit (PTI).

Three cycles after the Grant, the requester drives its Data Bus on-ramp for 8 bus cycles. The Data bus is 128 data bits plus the DataError bit and DataValid bit (130 bits total).

Along with the Grant to the requester, the central arbiter 108 sends flow control signals to the downstream data ramps:

Passthru: A data ramp 104 receiving a passthru pulse passes data from the specified ring input to its output for 8 cycles, starting 1 cycle after the pulse is received for the Tag Bus, and 3 cycles afterwards for the Data Bus.

Early data valid (EDV): A recipient device 102 receives an EDV pulse. It captures DTag data from the ramp DTag output during the next cycle, and two cycles after that it captures data from the ramp Data output for 8 cycles. The ramp controller 106 receives a bus-specific EDV, and controls the ramp output multiplexers with the same timing constraints.

The time from when any Grant or Passthru pulse is received at a ramp 104 for a specific ring until the next Grant or Passthru pulse is received at the same ramp for the same ring is eight cycles minimum. The time from when any EDV pulse is received at a ramp for a specific ring until the next EDV pulse is received at the same ramp for the same ring is eight cycles minimum.

Grant→Grant at a bus device 102 is eight or more cycles. A device 102 can only drive one ring at a time. The bus device Grant is the OR of the four ring Grants for its ramp 104.

EDV→EDV at a bus device is eight or more cycles. A unit 102 can only receive from one ring at a time. The bus device EDV is the OR of the four ring EDVs for its ramp 194.

Driving and receiving are independent. Each unit 102 is able to drive into its ramp 104 and receive from its ramp 104 simultaneously. If any unit 102 wants to send to itself, it can do so through the ramp 104.

The central arbiter 108 sends Grant, Passthru, and EDV pulses to the data ramp controllers 106 to manage the flow of data around the rings. The data ramp controllers 106 convert these pulses into control signals.

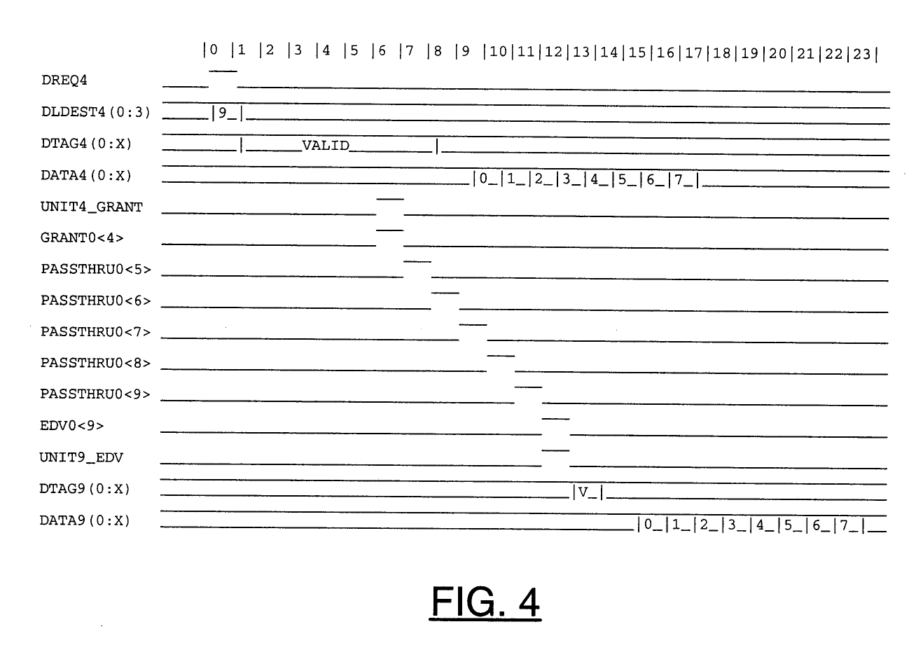

Referring also to FIG. 4, there is shown a timing diagram illustrating exemplary operations for unit 4, 102 to send data to unit 9, 102 and the central arbiter 108 decided that RING0 would be used for the transaction. Unit 4, 102 would present its DREQ to the interface, with DLDEST=9, the intended destination, as indicated in a line labeled DLDEST4 (0:3). The central arbiter 108 would determine that RING0 would be used, and issues a grant to node 4 of RING0. The Grant for unit 4,102 is the OR of the four node 4 ring grants. Unit 4, 102 starts driving its DTAG and Data ports at the specified times. The central arbiter 108 activates passthru pulses on the intervening ramps 5-9, 104, causing the data to move around the data ring RING0. Eventually the data reaches node 9, and the central arbiter 108 activates the node 9 EDV. The EDV for unit 9, 102 is the OR of the four node 9 ring EDVs. The data ramp 9, 104 presents the data to inputs of unit 9, 102 and unit 9, 102 captures the data at the specified times.

Referring to FIG. 5, the control apparatus or controller 106 for the switch 100 is composed of one request handler 502 per bus unit 102, one destination arbiter 504 per bus unit 102, and one ring arbiter per ring RING0 arbiter 506, RING1 arbiter 506, RING2 arbiter 506, and RING3 arbiter 506. The logic defining controllers 106 works together to grant data requests, manage the flow of data around the data rings, and to notify each recipient that its data has arrived.

As shown in FIG. 5, a bus unit 102 requests permission to drive onto the bus indicating a desired designation is indicated by an input REQUEST+DESTID applied to request handler 502.

Once it has received the bus unit request, the request handler 502 asks for permission to drive to the destination is indicated by an input REQUEST applied to the destination arbiter 504, and the destination arbiter 504 grants the request is indicated by an input GRANT applied to the request handler 502. Next the request handler 502 individually asks the RING0 arbiter 506, RING1 arbiter 506, RING2 arbiter 506, and RING3 arbiter 506 to use the respective ring as indicated by lines RING REQUESTS. Ring requests are composed of path information identifying which nodes need to be used by this request; request pending, for round robin calculation in ring arbiters 506; and request that is presented to one ring arbiter 506 at a time. One of the RING0 arbiter 506, RING1 arbiter 506, RING2 arbiter 506, and RING3 arbiter 506 issues a grant as indicated by lines RING GRANTS, and then controls the flow of data around the respective ring. The output of OR 508 is indicated by a line GRANT.

In operation of controllers 106, for example, the minimum delay between a data request and the granting of the data request is six bus cycles (including transport to and from the bus devices 102. All bus devices 102 have equal Request and Grant latency. Because fetch data from memory is a critical resource, a memory interface controller (MIC) Unit 102 advantageously is given priority over the other units during arbitration. The MIC Unit 102 also can be made equal priority with the other units by setting a configuration bit. This concept could be extended to other units 102 to establish, for example, quality of service behavior for high-priority and low-priority units.

The controller or control apparatus 106 maintains a view of pending requests and the current state of each ring's segments. With this state information, the control apparatus 106 can potentially grant one request per ring every three bus cycles.

The Method is as Follows:

Stage 0: Accept:

A dedicated request handler 502 per bus device latches each device's Request bus DReq (REQUEST)+Destination Unit ID (DESTID), and if the request bit is high request handler 502 saves the pending request state until the grant to the device occurs.

Stage 1: Destination Decode, Path Determination, Destination Arbitration: The destination of each request is decoded, and three things happen in parallel:

1) The path from the requester to the destination is calculated for both the clockwise and the counterclockwise rings. The path calculation is a simple decode based on the relative positions of requestor and destination on a ring. Solutions which span a distance of more than halfway around the ring can be eliminated from consideration at this point if desired, if multiple rings are available for use.

2) The request handler 502 calculates whether the path to the destination is free or not on each ring. A path is considered “free” on a ring if the requestor's node on that ring is not in use, and the “tail” bit for that node on that ring is not in use, or if the new request will not use any of the nodes currently in use on that ring. More detail on “in use” and “tail” in the ring arbitration description is provided below.

3) The request is forwarded to the destination arbiter 504 for the destination device 102, which arbitrates among its requesters in a round-robin fashion, and the winning request handler is notified. This is a stage where the MIC can be given priority over other units. The destination arbitration prevents multiple units from sending to the same destination at the same time, which must be avoided because of the rules governing the interface.

The request handler 502 then latches the path-free state for each ring and whether it has won its destination.

Stage 2: Pending Ring Request:

The request handler 502 uses the path-free and destination winner state to choose the optimum ring to make its initial request to. A “pending request” signal is sent to the selected ring arbiter 506. A request handler 502 cannot initiate a pending request until it has won its destination. This prevents deadlocks on the rings and data collisions from multiple transactions arriving at the destination simultaneously. If the current destination is the same as the prior transaction's destination, then the request handler 502 will select the ring it last used, as that path is the one most likely to free up first. Otherwise request handler 502 will choose the optimum ring for the new transaction. As time passes without a grant from the initially chosen ring, the request handler 502 will initiate pending requests to other useable rings to improve its odds of getting a grant. One key point is that “pending requests” feed into the round-robin logic of each ring arbiter 506, setting the stage for the stage 3 ring grant.

Stage 3: Ring Request and Ring Grant

Pending requests cause the round-robin pointer for each ring arbiter 506 to shift to the next valid requester and it holds on that state until the chosen requestor withdraws its pending request. It should be understood that other arbitration methods could be used.

At this point the request handler 502 makes a “ring request” to one of the rings on which it has a pending request and for which that path is “free”. Each cycle request handler 502 can make a request to one of the RING0 arbiter 506, RING1 arbiter 506, RING2 arbiter 506, and RING3 arbiter 506, which prevents request handler 502 from winning on two or more rings simultaneously when it is only capable of driving one.

In each ring arbiter 506, the ring requests are ANDed with the round robin state AND the “destination free” state, which is described further below, and if there is a match, a DGrant is issued to the winner. The DGrant causes a cascading series of events to occur.

First, the four ring Dgrants (one from each ring arbiter) for a particular bus port or data ramp are ORed together as indicated by OR gate 508 to form the DGrant (GRANT) for the requesting device at that port. The Grant causes the winning request handler to withdraw its destination request and all its pending ring requests, and resets the request handler 502 to accept the next request from its associated bus unit 102. At this point the DGrant on the selected ring causes an update to all the bookkeeping latches on that ring that are needed for the process. Latches keep track of which masters are driving data, which destinations are busy, which data ramps are “in use” on each ring, which ports need to receive an Early Data Valid pulse (EDV), which data ramps need to forward data to the next data ramp on a particular ring, and where the tail of each operation is on each ring, so that the next operation can be granted onto the ring at the optimum time to maximize bandwidth. Arbitration for a ring that has received a DGrant is blocked for two cycles to allow all the bookkeeping logic to catch up. This results, for a best case, in a DGrant every 3 cycles on a particular ring. Arbitration of the destination that was the target of the request is also blocked for two cycles for the same reason. Given different constraints, those knowledgeable in the art could implement a design that updates the bookkeeping logic in fewer cycles.

In operation, request handler 502 does a relative path calculation, and the calculation is performed only allowing a transaction to travel at most halfway around a ring, although it need not be restricted to that subset. These relative path calculations are converted to absolute paths when the information is passed to the ring arbiters. For example, if request handler 502 of unit 0, 102 wanted to send data to unit 6, 102, request handler 502 could legally go both directions. Relpathc(0:6) would all turn on, and so would relpathcc(0:6). When handler 0 makes a request to the RING0 or RING2 arbiter 506, request handler 502 would tell it that it is using nodes 0:6. But request handler 502 would convert the relpathcc such that it would tell the RING1 or RING3 arbiters 506 that it would use nodes 0, 11, 10, 9, 8, 7, 6 on that opposite-direction ring.

A bus unit 102 will receive a Ring Grant pulse when the following conditions are true:

Its request handler is requesting that ring, AND

Its requested destination is “free” (see conditions below), AND

The ring arbiter has selected its request handler to be the next winner, AND

The ring is not blocked from arbitrating due to a recent grant.

The ring grant pulses are used by the ramp controller, 106, to move the bus unit's data onto the designated ring. The OR of the ring grants are used by the bus unit (102) to control when to drive its data into the ramp.

The ring arbiter 506 generates Passthru pulses that are used by the ramp controllers, 106 to control the movement of data around the ring to the destination. These pulses are generated as follows (per ring node):

If the upstream node saw a grant or passthru pulse this cycle, AND the upstream node is not the final destination, THEN activate a passthru pulse for this node during the next cycle.

The ring arbiter 506 generates EDV pulses that are used by the ramp controller, 106 to control the movement of data off the ring to the final destination unit. The OR of the EDVs is used by the destination unit (102) to control when it receives its data from the ramp. These pulses are generated as follows (per ring node):

If this node receives a grant or passthru pulse this cycle, AND this node is the final destination (TDestBusy is valid), THEN activate an EDV pulse for this node during the next cycle.

TDestBusy is used to track whether each destination node has had its EDV sent. Each node has a tdestbusy bit, which is set when a grant targeting it occurs, and is reset when the EDV for the node occurs. Each ring arbiter maintains a set of tdestbusy bits.

Bookkeeping Logic:

The Grant condition above involved knowing whether the destination node is “free”. A destination is “free” if it is not currently in use, or if the next transaction that is put on the ring destined for it will arrive at the destination after the current transaction has completed. Several different signals must be created and tracked to determine the “free” state of a destination.

In order to initiate a new transaction, the nodes that are currently in use must be known. Each node has an “inuse” bit, which is set when a grant occurs, that includes it as part of the path the transaction will take from source to destination, including the source and destination nodes. It is held valid for as long as the transaction is, or may be, using that node. The inuse bits representing the nodes from source node to destination node are set with a grant, and each is held valid as long as the upstream node's inuse or tail bits are valid.

At present, an operation is defined to always take 8 beats at each node from source to destination inclusive on the ring. A method is needed to calculate where the “tail” of the transaction is, so that collisions can be avoided. This also make it possible to grant another transaction onto the same ring just behind the first transaction, allowing them to follow each other around the ring as if they were two trains on the same track.

The preferred method of tracking the tail is to have a “tail” bit for each node. At the time of the grant, for example, the five closest upstream tail bits from the source node will have their tail bits set. Each tail bit remains active until the tail bit upstream from it goes inactive. Five nodes and not seven nodes are used in this implementation since from the time a tail bit goes inactive until the grant logic determines that another grant can be issued, takes two cycles. Leaving out two extra tail bits allows two transactions to occupy the ring without a gap between them. Note that if the size of the transaction is known, those skilled in the art can adjust the tail bit calculation to accommodate variable sizes of transactions.

Livelock avoidance is provided: Since multiple operations can simultaneously occupy adjoining parts of a ring, an inuse bit may get “stale”, i.e., be held active by the upstream ring state even though it is no longer involved in a transaction. This can prevent that node from being used in a new transaction for as long as the upstream traffic causes it appear to be in use. Thus, it is advisable to find a way to reset these stale inuse bits. One method is as follows: if the node is not currently designated as a destination (the corresponding destbusy bit is inactive), and the downstream node inuse bit is invalid, then the inuse bit is “stale”, and it is permissible to reset it, and thus free the node for new transactions.

Deadlock avoidance is provided: Since a tail bit depends only upon its upstream neighbor for maintaining its state, if a condition arose where all the tail bits in one ring were active, then the ring would deadlock in a state where no more grants could be issued. To avoid this, a grant will not be issued unless the 6^{th} tail bit upstream of the source node of the op is inactive. This guarantees that there is always at least one tail bit in the inactive state.

Another bookkeeping function is destbusy logic, which is used to track whether a node is in use as a destination. Each node has a destbusy bit, which is set when a grant targeting it occurs, and it is held valid for as long as the destination node remains “inuse”. Each ring arbiter 506 maintains a set of destbusy bits.

As described above, the inuse bits can be held active by recurring upstream ops, thus a destbusy bit might be held active falsely, possibly preventing that destination from being accessed until the destbusy bit has been reset. A livelock prevention control circuit monitors the destbusy bits and resets them if they stay on too long. The longest a destination can be busy for a single transaction on a 12-node ring is 12 cycles (6 nodes from source to destination+8 cycles for the transaction—2 cycles for overhead). This circuit checks every 12 cycles to see if each destbusy bit remains valid for two consecutive intervals without an intervening set pulse. If this condition occurs, the destbusy is assumed to be falsely held valid, and is reset.

Additional logic provides for maximizing performance when units send transactions to a particular destination from different rings. One objective is to allow the “head” of the second transaction to arrive at the destination the cycle after the “tail” of the first transaction has arrived. For example, when a particular unit is going to send to a particular destination on a particular ring, there is a given unit on each ring that can be monitored to decide when data can be launched on this ring and not collide with the prior unit's data arriving at the destination ramp from the other ring. That position is the “mirror image” position on the opposite direction rings, and the matching position on the same-direction ring.

For example in FIG. 1, if unit 0, 102 wishes to send data to unit 2, 102 on the ring RING0, and unit 2 is currently receiving data on RING2, which is known by monitoring the destbusy bits, then the RING2 node 0 inuse and tail bits could be monitored to know when it is safe to send data on RING0. If RING2 node 0 is no longer involved with a transaction, then we know that RING2 node 2 will soon complete its transaction and starting a new transaction on RING0 will not collide with it. Likewise, if the current transaction to unit 2, 102 was on RING1, the RING1 node 4 inuse and tail bits would be monitored to know when it was safe to send data on RING0, because RING1 node 4 is the same distance from node 2 on the counterclockwise RING1 as node 0 is from node 2 on clockwise RING0. This information is evaluated as part of the decision to generate a grant pulse. Note that if the node being monitored on another ring becomes involved in a transaction unrelated to the one involving the desired destination, the performance gain may not be realized. Instead the logic would simply wait until the destbusy bit of the destination unit 102 was reset, and it would send the grant at that time. The destination node would see a gap between the two transactions for that case.

It should be understood that the present invention is not limited to the above representative examples and detailed operations, various other implementations within the scope of the invention can be provided by one skilled in the art.

While the present invention has been described with reference to the details of the embodiments of the invention shown in the drawing, these details are not intended to limit the scope of the invention as claimed in the appended claims.

What is claimed is:

1. Control apparatus for implementing control of a multiple-ring hybrid crossbar partially non-blocking data switch, the data switch including a plurality of bus units, each bus unit coupled to a respective data ramp and a plurality of data rings connected between each of the data ramps, with each data ramp device only connected to the two adjacent data ramp devices, said control apparatus comprising:
a respective request handler for an associated bus unit,
a respective destination arbiter for an associated bus unit, and
a respective ring arbiter for an associated one of the plurality of data rings;
said request handler receiving a request from the respective associated bus unit and saving the pending request state until a grant to the bus unit occurs; the request including a destination unit identifier;
said request handler forwarding the request to the destination arbiter for the identified destination unit;
said destination arbiter granting the request;
said request handler individually asking one of said ring arbiters to use the respective ring responsive to said destination arbiter granting the request; and
one said ring arbiter issuing a grant and controlling data flow around the respective ring.

2. Control apparatus for implementing control of a multiple-ring hybrid crossbar partially non-blocking data switch as recited in claim 1 wherein said destination arbiter prevents multiple units from sending to the identified destination unit at one time.

3. Control apparatus for implementing control of a multiple-ring hybrid crossbar partially non-blocking data switch as recited in claim 1 wherein said destination arbiter arbitrates between each of multiple requester handlers.

4. Control apparatus for implementing control of a multiple-ring hybrid crossbar partially non-blocking data switch as recited in claim 1 wherein said destination arbiter notifies a winning request handler of the multiple requester handlers by granting the request to said request handler.

5. Control apparatus for implementing control of a multiple-ring hybrid crossbar partially non-blocking data switch as recited in claim 1 wherein said request handler only initiates a pending request to one of said ring arbiters after said destination arbiter grants the request, thereby preventing deadlocks on the rings and data collisions from multiple transactions arriving at the destination simultaneously.

6. Control apparatus for implementing control of a multiple-ring hybrid crossbar partially non-blocking data switch as recited in claim 1 wherein said request handler calculates a path from the requester to the destination.

7. Control apparatus for implementing control of a multiple-ring hybrid crossbar partially non-blocking data switch as recited in claim 1 wherein said plurality of data rings includes clockwise and counterclockwise rings, and wherein said request handler calculates a path from the requester to the destination for both the clockwise and the counterclockwise rings.

8. Control apparatus for implementing control of a multiple-ring hybrid crossbar partially non-blocking data switch as recited in claim 7 wherein said request handler calculates whether the path to the destination is free on each ring.

9. Control apparatus for implementing control of a multiple-ring hybrid crossbar partially non-blocking data switch as recited in claim 8 wherein said request handler determines the identified path is free on a ring when a node of the requestor on the ring is not in use, and a tail bit for the node on the ring is not in use.

10. Control apparatus for implementing control of a multiple-ring hybrid crossbar partially non-blocking data switch as recited in claim 8 wherein said request handler request handler selects a ring for an initial request to one of the ring arbiters using a free state of the identified path and responsive to said destination arbiter granting the request.

11. Control apparatus for implementing control of a multiple-ring hybrid crossbar partially non-blocking data switch as recited in claim 8 wherein said ring arbiters select from a plurality of pending requests.

12. A method for implementing control of a multiple-ring hybrid crossbar partially non-blocking data switch, the data switch including a plurality of bus units, each bus unit coupled to a respective data ramp and a plurality of data rings connected between each of the data ramps, with each data ramp device only connected to the two adjacent data ramp devices, said control method comprising the steps of:
providing a respective request handler for an associated bus unit,
providing a respective destination arbiter for an associated bus unit, and
providing a respective ring arbiter for an associated one of the plurality of data rings;
applying a request to said respective request handler from the associated bus unit; saving a pending request state until a grant to the bus unit occurs; the request including a destination unit identifier;
forwarding the request to the destination arbiter for the identified destination unit; and granting the request by said destination arbiter;
requesting use of one of the data rings responsive to said destination arbiter granting the request; and
issuing a grant and controlling data flow around the respective ring with one said ring arbiter.

13. A method for implementing control of a multiple-ring hybrid crossbar partially non-blocking data switch as recited in claim 12 wherein using said destination arbiter for granting the request prevents multiple units from sending to the identified destination unit at the same time.

14. A method for implementing control of a multiple-ring hybrid crossbar partially non-blocking data switch as recited in claim 12 wherein granting the request by said destination arbiter includes arbitrating between each of multiple requester handlers.

15. A method for implementing control of a multiple-ring hybrid crossbar partially non-blocking data switch as recited in claim 12 wherein forwarding the request to the destination arbiter further includes calculating a path to the destination unit, and selecting one of said ring arbiters for requesting use of one of the data rings responsive to said calculated path and said destination arbiter granting the request.

16. A method for implementing control of a multiple-ring hybrid crossbar partially non-blocking data switch as recited in claim 12 wherein requesting use of one data ring responsive to said destination arbiter granting the request includes initiating a pending request to one of said ring arbiters only after said destination arbiter grants the request, thereby preventing deadlocks on the rings and data collisions.

17. A method for implementing control of a multiple-ring hybrid crossbar partially non-blocking data switch as recited in claim 12 includes selecting from a plurality of pending requests with said ring arbiters.

18. A control apparatus for a multiple-ring data switch comprising:
a respective request handler for an associated bus unit of a plurality of bus units,
a respective destination arbiter for an associated bus unit of the plurality of bus units, and
a respective ring arbiter for an associated one of a plurality of data rings;
said request handler receiving a request from the respective associated bus unit and saving the pending request state until a grant to the bus unit occurs; the request including a destination unit identifier;
said request handler forwarding the request to the destination arbiter for the destination unit;
said destination arbiter granting the request;
said request handler individually asking one of said ring arbiters to use the respective ring responsive to said destination arbiter granting the request; and
one said ring arbiter issuing a grant and controlling data flow around the respective ring.

19. A control apparatus for a multiple-ring data switch as recited in claim 18 wherein said plurality of data rings includes clockwise and counterclockwise rings, and wherein said request handler calculates a path from the requester to the destination for both the clockwise and the counterclockwise rings.

20. A control apparatus for a multiple-ring data switch as recited in claim 18 wherein said request handler request handler selects a ring for an initial request to one of the ring arbiters using a free state of an identified path and responsive to said destination arbiter granting the request.

21. A control apparatus for a multiple-ring data switch as recited in claim 18 wherein said request handler only initiates a pending request to one of said ring arbiters at a time after said destination arbiter grants the request.

22. A control apparatus for a multiple-ring data switch as recited in claim 18 wherein said destination arbiter arbitrates between each of multiple requester handlers, and notifies a winning request handler of the multiple requester handlers by granting the request to said request handler.

23. A control apparatus for a multiple-ring data switch as recited in claim 18 wherein said ring arbiters selects between a plurality of pending requests.
